(19) United States
(12) Patent Application Publication
(10) Pub. No.: US 2023/0192050 A1
(43) Pub. Date: Jun. 22, 2023

(54) FUNCTIONAL UNIT, HYDRAULIC MOTOR VEHICLE BRAKE SYSTEM, METHOD FOR OPERATING A HYDRAULIC MOTOR VEHICLE BRAKE SYSTEM, AND MOTOR VEHICLE CONTROL UNIT

(71) Applicant: ZF Active Safety GmbH, Koblenz (DE)

(72) Inventor: Boris Koeth, Weitersburg (DE)

(21) Appl. No.: 18/082,255

(22) Filed: Dec. 15, 2022

(30) Foreign Application Priority Data
Dec. 21, 2021 (DE) 102021124165.5

(51) Int. Cl. B60T 8/94; B60T 13/14; B60T 13/68

(52) U.S. Cl. CPC B60T 8/94; B60T 13/148; B60T 13/686; B60T 2270/402; B60T 2270/413

(57) ABSTRACT

A second functional unit for brake pressure control at each wheel brake of a multiplicity of wheel brakes in a redundant manner in relation to a first functional unit of a hydraulic motor vehicle brake system is disclosed. The second functional unit has at least one electrical brake pressure generator that is configured to generate a respective brake pressure, on a wheel-specific basis, at the multiplicity of wheel brakes. A hydraulic motor vehicle brake system, method for operating a hydraulic motor vehicle brake system, and motor vehicle control unit are also disclosed.

### CROSS-REFERENCE TO RELATED APPLICATION

This application claims priority to German Priority Application No. 102021134165.5, filed Dec. 21, 2021, the disclosure of which is incorporated herein by reference in its entirety.

### TECHNICAL FIELD

The disclosure relates to a functional unit, in particular second functional unit, for brake pressure control in a redundant manner in relation to a first functional unit of a hydraulic motor vehicle brake system. The disclosure furthermore relates to a hydraulic motor vehicle brake system, to a method for operating a hydraulic motor vehicle brake system, and to a motor vehicle control unit.

### BACKGROUND

Motor vehicle brake systems for autonomous or partially autonomous driving must be of redundant design, because it cannot be assumed here that the driver is situated in the vehicle (for example in remote-controlled parking (RCP) operation) or that the driver can actuate a brake pedal for so-called push-through (PT) operation without delay, for example if their view is averted from the traffic situation. It is therefore stipulated that brake systems for autonomous or partially autonomous driving have not only a first functional unit that provides an electrically actuatable main braking function but also a further, second functional unit that implements an electrically actuatable auxiliary braking function in a redundant manner.

For example, WO 2018/134333 A1 discloses a motor vehicle brake system with redundant brake pressure control by a first and a second functional unit.

### SUMMARY

What is needed is an arrangement that structurally and/or functionally improves a functional unit as mentioned in the introduction. The disclosure is furthermore based on structurally and/or functionally improving a hydraulic motor vehicle brake system as mentioned in the introduction. The disclosure is furthermore based on structurally and/or functionally improving a method as mentioned in the introduction for operating a hydraulic motor vehicle brake system, and also a motor vehicle control unit as mentioned in the introduction. For example, it is sought to structurally and/or functionally improve the architecture of the second functional unit.

One functional unit, such as a second functional unit, may be for brake pressure control at each wheel brake of a multiplicity of wheel brakes in a redundant manner in relation to a first functional unit of a hydraulic motor vehicle brake system. The motor vehicle brake system may be for a motor vehicle. The motor vehicle may be a passenger motor vehicle or a heavy goods vehicle. The motor vehicle and/or the motor vehicle brake system may have wheel brakes.

The second functional unit may have at least one electrical brake pressure generator, such as a second brake pressure generator. The brake pressure generator of the second functional unit may be configured to generate a respective brake pressure, for example on a wheel-specific basis, at the multiplicity of wheel brakes.

The second functional unit may be configured to implement, in a redundant manner, one, several or all brake pressure control functions that the first functional unit is capable of implementing. This redundancy created by the second functional unit may for example be activated in the event of a fault of the first functional unit. Exemplary brake pressure control functions may comprise one or more of the following functions: anti-lock system, traction control, driving dynamics control and automatic adaptive cruise control.

The second functional unit may have one, two, three, four, five or more inlets, such as hydraulic fluid inlets. The one or more inlets of the second functional unit may be coupled or couplable to outlets, such as hydraulic fluid outlets, of the first functional unit. For example, the second functional unit may have four inlets, such as hydraulic fluid inlets, which are in each case coupled or couplable to an outlet, such as hydraulic fluid outlets, of the first functional unit. The inlets of the second functional unit and/or the outlets of the first functional unit may be assigned to in each case at least one wheel brake.

The second functional unit may comprise, for example for the implementation of the brake pressure control, a first valve arrangement, such as a per wheel brake of the multiplicity of wheel brakes. The first valve arrangement may be activatable for the brake pressure control at the corresponding wheel brake.

The first valve arrangements may comprise in each case one first valve unit that is connected in parallel with respect to the at least one electrical brake pressure generator of the second functional unit. The first valve unit may be a switched or switchable valve unit. The first valve unit may be configured to, during the operation of the brake pressure generator of the second functional unit, assume a blocking position at least counter to a conveying direction of the brake pressure generator of the second functional unit, and/or to otherwise assume a passage position. In its electrically activated state, the first valve unit may have a blocking action, or assume its blocking position. In its electrically non-activated state, the first valve unit may assume its passage position. The first valve unit may be a two-way valve, for example 2/2 directional valve.

Additionally or alternatively, the first valve arrangements may comprise in each case one second valve unit. The second valve unit may be a switched or switchable valve unit. The second valve unit may be configured to couple the wheel brake assigned to the respective first valve arrangement, for example for the purposes of increasing brake pressure, selectively to an inlet, such as hydraulic fluid inlet, of the second functional unit and/or to the brake pressure generator of the second functional unit. The second valve unit may be configured to, during the operation of the brake pressure generator of the second functional unit, assume a position for blocking the inlet of the second functional unit and for allowing a passage of fluid, such as hydraulic fluid, at least in a conveying direction of the brake pressure generator of the second functional unit. The second valve unit may be configured to, when the brake pressure generator of the second functional unit is not in operation, assume a position for allowing a passage of fluid, such as hydraulic fluid, from the inlet of the second functional unit to the wheel brake and for allowing a passage of fluid, such as hydraulic fluid, at least in a conveying direction of the brake pressure generator of the second functional unit. The second valve unit may, in its electrically activated state, have a blocking action or assume its blocking position for the inlet of the second functional unit and/or its passage position for allowing a passage of fluid, such as hydraulic fluid, at least in a conveying direction of the brake pressure generator of the second functional unit. The second valve unit may be configured to, in its electrically non-activated state, assume its passage position for allowing a passage of fluid, such as hydraulic fluid, from the inlet of the second functional unit to the wheel brake and for allowing a passage of fluid, such as hydraulic fluid, at least in a conveying direction of the brake pressure generator of the second functional unit. The second valve unit may be a two-way valve or three-way valve, for example 3/2 directional valve.

The second functional unit may comprise a third valve unit, for example per wheel brake of the multiplicity of wheel brakes. The third valve unit may be a switched or switchable valve unit. The third valve unit may be configured to selectively dissipate brake pressure at the wheel brake assigned to the third valve unit. The outlets, such as hydraulic fluid outlets, of the third valve units of the second functional unit, which outlets are directed away from the wheel brakes, may be coupled and/or couplable to a first unpressurized reservoir of the first functional unit and/or to a second unpressurized reservoir of the second functional unit. The third valve unit may be configured to assume a blocking position and/or to assume a passage position. In its electrically non-activated state, the third valve unit may have a blocking action, or assume its blocking position. In its electrically activated state, the third valve unit may assume its passage position. The third valve unit may be a two-way valve, for example 2/2 directional valve.

The brake pressure generator of the second functional unit may have at least one inlet, such as a hydraulic fluid inlet. The at least one inlet of the brake pressure generator of the second functional unit may be coupled or couplable to an inlet, such as a hydraulic fluid inlet, of the second functional unit and/or to an outlet, such as a hydraulic fluid outlet, of the first functional unit.

The second functional unit may comprise at least one fluid accumulator provided at an inlet side of the brake pressure generator of the second functional unit. For example, the second functional unit may comprise two fluid accumulators. For example, the second functional unit may comprise a first fluid accumulator, which is assigned to a first brake circuit, and a second fluid accumulator, which is assigned to a second brake circuit. The at least one fluid accumulator may be coupled or couplable to at least one inlet, such as a hydraulic fluid inlet, of the second functional unit and/or to an outlet, such as a hydraulic fluid outlet, of the first functional unit. The at least one fluid accumulator may be coupled or couplable to at least one inlet, such as a hydraulic fluid inlet, of the brake pressure generator of the second functional unit. For example, a first fluid accumulator may be coupled or couplable to a first inlet, such as a hydraulic fluid inlet, of the brake pressure generator of the second functional unit, and a second fluid accumulator may be coupled or couplable to a second inlet, such as a hydraulic fluid inlet, of the brake pressure generator of the second functional unit. Furthermore, the first fluid accumulator may be coupled or couplable to one inlet, such as a hydraulic fluid inlet, of the second functional unit and a second fluid accumulator may be coupled or couplable to another inlet, such as a hydraulic fluid inlet, of the second functional unit.

The fluid accumulator may be configured as a fluid pressure accumulator, for example as a membrane-type accumulator or as a spring-loaded piston-type accumulator, in order to store hydraulic fluid under pressure. The fluid accumulator may be a low-pressure accumulator. As an alternative to this, the fluid accumulator may be configured without a facility to pressurize hydraulic fluid.

The at least one fluid accumulator may be configured as a piston-type accumulator with a cylinder and with a piston received displaceably therein. The piston may have an accumulation position when the cylinder has been filled. The piston-type accumulator may have an elastic element, such as a spring element, for actuating the piston. Alternatively, the piston-type accumulator may be configured without an elastic element automatically transferring the piston, for example into its accumulation position. In this case, the transfer of the piston into its accumulation position may be effected by the hydraulic fluid flowing back from the wheel brake into the cylinder.

If hydraulic fluid is withdrawn from the filled cylinder, the piston can move out of its accumulation position, for example by the elastic element. The piston may be charged with atmospheric pressure. The piston-type accumulator may be arranged in a fluid path of at least one of the wheel brakes of the multiplicity of wheel brakes such that a hydraulic fluid flowing from the wheel brake in the direction of an inlet of the second functional unit and/or in the direction of the first functional unit can force the piston into its accumulation position.

The brake pressure generator of the second functional unit may have at least one inlet, such as a hydraulic fluid inlet. The at least one inlet of the brake pressure generator of the second functional unit may be coupled or couplable to a first unpressurized reservoir for hydraulic fluid of the first functional unit. The second functional unit may have a second unpressurized reservoir for hydraulic fluid. The at least one inlet of the brake pressure generator of the second functional unit may be coupled or couplable to the second unpressurized reservoir for hydraulic fluid of the second functional unit.

The second functional unit may have a fifth inlet, such as a hydraulic fluid inlet. The fifth inlet may be coupled or couplable to the first unpressurized reservoir for hydraulic fluid of the first functional unit. The at least one inlet of the brake pressure generator of the second functional unit may be coupled or couplable to the fifth inlet of the second functional unit. For example, two inlets of the brake pressure generator of the second functional unit may be coupled or couplable to the fifth inlet of the second functional unit.

The at least one inlet of the brake pressure generator of the second functional unit may be directed towards a corresponding inlet of the second functional unit. The brake pressure generator of the second functional unit may have at least one outlet, such as a hydraulic fluid outlet. The brake pressure generator of the second functional unit may for example have two outlets. Each outlet may be assigned to one brake circuit. The at least one outlet of the brake pressure generator of the second functional unit may be directed towards at least one wheel brake of the multiplicity of wheel brakes.

The second functional unit may comprise a second valve arrangement, for example per wheel brake of the multiplicity of wheel brakes. The second valve arrangement may be arranged in a fluid line between the at least one outlet of the brake pressure generator of the second functional unit and the wheel brake assigned to the respective second valve arrangement.

The second valve arrangements may comprise in each case at least one fourth valve unit. The fourth valve unit may be configured to selectively assume a blocking position and/or passage position. The fourth valve unit may be a switched or switchable valve unit. The fourth valve unit may be configured to assume a blocking position and/or to assume a passage position. In its electrically non-activated state, the fourth valve unit may have a blocking action, or assume its blocking position. Alternatively, in its electrically non-activated state, the fourth valve unit may assume its passage position. In its electrically activated state, the fourth valve unit may assume its passage position. Alternatively, in its electrically activated state, the fourth valve unit may have a blocking action, or assume its blocking position. The fourth valve unit may be a two-way valve, for example 2/2directional valve.

At least one of the second valve arrangements may have two fourth valve units, which are for example arranged in series. For example, two of the second valve arrangements may have in each case two fourth valve units, which are for example arranged in series. One such second valve arrangement may be provided per brake circuit.

In addition or alternatively, for example as an alternative to the fourth valve unit, the second valve arrangements may comprise in each case at least one fifth valve unit. The fifth valve unit may be configured as a check valve. The check valve may allow a flow of hydraulic fluid, from the brake pressure generator of the second functional unit, to the respective wheel brake. The check valve may have a blocking action in the opposite direction. The check valve may be spring-loaded. An opening pressure for opening the check valve may be less than 1 bar, for example less than 0.5 bar.

At least one of the second valve arrangements may have a fourth valve unit, which is configured to selectively assume a blocking position and/or passage position, and a fifth valve unit, which is configured as a check valve which allows a flow of hydraulic fluid to the respective wheel brake and which has a blocking action in the opposite direction. Here, the fourth and fifth valve units may be arranged in series.

For example, two of the second valve arrangements may have in each case one fourth valve unit, which is configured to selectively assume a blocking position and/or passage position, and a fifth valve unit, which is configured as a check valve which allows a flow of hydraulic fluid to the respective wheel brake and which has a blocking action in the opposite direction. Here, the fourth and fifth valve units may be arranged in series.

The multiplicity of wheel brakes may comprise all wheel brakes of the motor vehicle brake system or of the motor vehicle. The second functional unit may be configured such that the brake pressure generator of the second functional unit can implement a_{;} for example wheel-specific, brake pressure build-up at all wheel brakes of the motor vehicle. The brake pressure build-up may for example take place in the context of brake pressure control. The motor vehicle brake system and/or the motor vehicle may comprise two front-wheel brakes and two rear-wheel brakes. The wheel brakes, or the front-wheel brakes and rear-wheel brakes, may be connected to the second functional unit.

The brake pressure generator of the second functional unit may comprise at least one electric motor. The at least one electric motor may be a DC motor. The electric motor may be configured to drive at least one fluid-conveying device and/or cylinder-piston arrangement and/or multi-piston pump.

The brake pressure generator of the second functional unit may comprise at least one fluid-conveying device, such as piston pump and/or radial piston pump and/or gear pump and/or multi-piston pump, which is actuatable by the electric motor. The brake pressure generator of the second functional unit may comprise two, for example exactly two and/or only two, fluid-conveying devices, such as piston pumps and/or radial piston pumps and/or gear pumps, which are actuatable by the electric motor.

In each case one front-wheel brake and one rear-wheel brake may be jointly assigned and/or connected to one fluid-conveying device. The two front-wheel brakes may be jointly assigned and/or connected to one fluid-conveying device. The two rear-wheel brakes may be jointly assigned and/or connected to the other fluid-conveying device.

The brake pressure generator of the second functional unit may comprise at least one, for example double-acting or single-acting, cylinder-piston arrangement that is actuatable by the electric motor. The cylinder-piston arrangement may be configured in the manner of a plunger arrangement.

The brake pressure generator of the second functional unit may comprise a multi-piston pump that is actuatable by the electric motor. In each case at least two of the wheel brakes may be jointly assigned and/or connected to one piston of the multi-piston pump. For example, in each case exactly two or only two wheel brakes may be jointly assigned and/or connected to one piston of the multi-piston pump.

The multi-piston pump may comprise two for example exactly two and/or only two, pistons. In each case one front-wheel brake and one rear-wheel brake may be jointly assigned and/or connected to one piston. The two front-wheel brakes may be jointly assigned and/or connected to one piston. The two rear-wheel brakes may be jointly assigned and/or connected to the other piston.

The second functional unit may comprise a control unit, such as a second control unit. The control unit of the second functional unit may be configured to activate the brake pressure generator of the second functional unit and/or one or more valve arrangements and/or valve units of the second functional unit during a brake pressure control operation of the second functional unit.

The first functional unit may comprise a control unit, such as a first control unit. The control unit of the first functional unit may be configured to activate the brake pressure generator of the first functional unit and/or one or more valve arrangements and/or valve units of the first functional unit during a brake pressure control operation of the first functional unit.

A common control unit may be provided for the first functional unit and second functional unit.

A hydraulic motor vehicle brake system may be for redundant brake pressure control and/or may have this and/or be configured for this. The hydraulic motor vehicle brake system may be for a motor vehicle. The motor vehicle may be a passenger motor vehicle or a heavy goods vehicle. The motor vehicle and/or the motor vehicle brake system may have wheel brakes, such as front-wheel brakes and/or rear-wheel brakes. The motor vehicle brake system may be configured as described above and/or below.

The motor vehicle brake system may comprise a first functional unit. The first functional unit may have a first electrical brake pressure generator. The first brake pressure generator of the first functional unit may be configured to generate a respective brake pressure at a multiplicity of wheel brakes, for example at all wheel brakes. The first functional unit may comprise a brake cylinder that is couplable or coupled to a brake pedal. The first functional unit may be configured as described above and/or below.

The motor vehicle brake system may comprise a second functional unit. The second functional unit may be configured to implement a brake pressure at each wheel brake of the multiplicity of wheel brakes, for example on a wheel-specific basis, in a redundant manner in relation to the first functional unit. The second functional unit may be configured as described above and/or below.

The two functional units may be logically and/or physically separate from one another. Functional units that are physically separate from one another may, at least in terms of some of their components, be accommodated in different housings or housing parts. The different housings or housing parts may be fastened to one another directly, that is to say at least approximately without a spacing, and thus be regarded as two partial housings of a superordinate overall housing.

A method may be for operating a hydraulic motor vehicle brake system. The hydraulic motor vehicle brake system may be configured as described above and/or below.

The method may comprise the step of: detecting a requirement for brake pressure control in the absence of functionality of the first functional unit.

The method may comprise the step: in response to the detection of a requirement for brake pressure control, performing brake pressure control at at least one wheel brake of the multiplicity of wheel brakes by the second functional unit.

The detection of a requirement for brake pressure control and the detection of an absence of functionality of the first functional unit may be coherent steps. The detection of a requirement for brake pressure control and the detection of an absence of functionality of the first functional unit may be mutually separate steps that are performed in any sequence. In one variant, a lack of functionality of the first functional unit may itself constitute the requirement for brake pressure control.

A computer program can cause a device, such as a motor vehicle control unit or control unit system, to carry out the method described above and/or below, for operating a hydraulic motor vehicle brake system. A computer program may comprise a program code in order, when the computer program is executed on a processor, to carry out the method described above and/or below, for operating a hydraulic motor vehicle brake system. A computer program product may cause a, for example electronic, controller and/or control and/or processing unit, a processor or a computer, to carry out the method described above and/or below, for operating a hydraulic motor vehicle brake system. For this purpose, the computer program may have corresponding datasets and/or program code and/or the computer program and/or a memory medium for storing the datasets and/or the programme.

A control unit, such as a motor vehicle control unit, or control unit system (for example composed of multiple control units), may be for a hydraulic motor vehicle brake system, of a motor vehicle. The hydraulic motor vehicle brake system may be configured as described above and/or below. The control unit or control unit system may comprise a computer program. The computer program may be configured as described above and/or below. The control unit or control unit system may have at least one processor and/or at least one memory. The memory may comprise and/or store program code, such as program code or the computer program. The program code may, when executed by the processor, cause the steps of the method described above and/or below, for operating a hydraulic motor vehicle brake system, to be carried out.

With the disclosure, an improved architecture of the second functional unit can be made possible. The second functional unit can be structurally and/or functionally improved. Performance and/or efficiency can be improved and/or increased.

### BRIEF DESCRIPTION OF DRAWINGS

Exemplary arrangements of the disclosure will be described in more detail below with reference to figures, in which, schematically and by way of example:

FIG. 1 shows a hydraulic circuit of a first variant of a second functional unit;

FIG. 2 shows a hydraulic circuit of a second variant of a second functional unit;

FIG. 3 shows a hydraulic circuit of a third variant of a second functional unit;

FIG. 4 shows a hydraulic circuit of a fourth variant of a second functional unit;

FIG. 5 shows a hydraulic circuit of a fifth variant of a second functional unit; and

FIG. 6 shows a hydraulic circuit of a sixth variant of a second functional unit.

### DETAILED DESCRIPTION

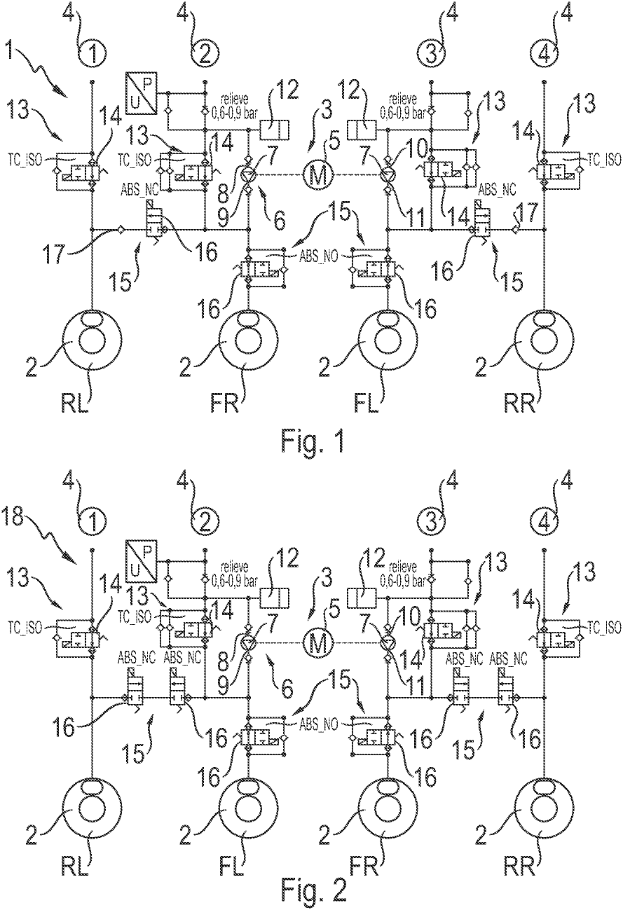

FIG. 1 schematically shows a hydraulic circuit diagram of a first variant of a second functional unit 1 for brake pressure control at each wheel brake 2 of a multiplicity of wheel brakes 2 in a redundant manner in relation to a first functional unit (not illustrated in FIG. 1) of a hydraulic motor vehicle brake system. The wheel brakes 2 comprise two front-wheel brakes FR, FL and two rear-wheel brakes RL, RR and are connected to the second functional unit 1. The second functional unit 1 has an electrical brake pressure generator 3 that is configured to generate a respective brake pressure at the multiplicity of wheel brakes 2, on a wheel-specific basis.

The second functional unit has four hydraulic fluid inlets 4, in this case numbers 1 to 4, which are respectively coupled or couplable to a hydraulic fluid outlet of the first functional unit. The hydraulic fluid inlets 4 of the second functional unit 1 are assigned to in each case at least one wheel brake 2.

The brake pressure generator 3 of the second functional unit 1 has a multi-piston pump 6 which is configured as a fluid-conveying device and which is actuatable by an electric motor 5, wherein two of the wheel brakes 2 are jointly assigned to one piston 7 of the multi-piston pump 6 and are connected thereto via fluid lines. Alternatively, a double-acting cylinder-piston arrangement that is actuatable by an electric motor may be provided.

As shown in FIG. 1, the multi-piston pump 6 has exactly two pistons 7. In each case one front-wheel brake FR or FL and one rear-wheel brake RL or RR are jointly assigned, and/or connected via fluid lines, to one piston 7.

The brake pressure generator 3 of the second functional unit 1 has a first hydraulic fluid inlet 8 and a first hydraulic fluid outlet 9, which are assigned to one piston 7. Furthermore, the brake pressure generator 3 of the second functional unit 1 has a second hydraulic fluid inlet 10 and a second hydraulic fluid outlet 11, which are assigned to the other piston 7. The hydraulic fluid outlets 9, 11 of the brake pressure generator 3 of the second functional unit 1 are directed towards at least one wheel brake 2. The hydraulic fluid inlets 8, 10 of the brake pressure generator 3 of the second functional unit 1 are directed towards the second hydraulic fluid inlet 4 and the third hydraulic fluid inlet 4, respectively, of the second functional unit 1. The first hydraulic fluid inlet 8 of the brake pressure generator 3 is coupled or couplable via a fluid line to the second hydraulic fluid inlet 4 of the second functional unit 1. The second hydraulic fluid inlet 10 of the brake pressure generator 3 is coupled or couplable via a fluid line to the third hydraulic fluid inlet 4 of the second functional unit 1.

Two fluid accumulators 12 are provided at the inlet side of the brake pressure generator 3 of the second functional unit 1, wherein one fluid accumulator 12 is coupled or couplable via a fluid line to the first hydraulic fluid inlet 8 of the brake pressure generator 3 and the other fluid accumulator 12 is coupled or couplable via a fluid line to the second hydraulic fluid inlet 10 of the brake pressure generator 3. Furthermore, each fluid accumulator 12 is coupled or couplable via fluid lines to two wheel brakes 2. The fluid accumulators 12 are configured as piston-type accumulators with a cylinder and with a piston received displaceably therein, wherein the piston has an accumulation position when the cylinder has been filled. The two fluid accumulators 12 are arranged in each case in a fluid path of at least one wheel brake 2 such that a hydraulic fluid flowing from the wheel brake 2 in the direction of the second hydraulic fluid inlet 4 or of the third hydraulic fluid inlet 4 of the second functional unit 1 can force the piston of the respective fluid accumulator 12 into its accumulation position.

Furthermore, to implement the brake pressure control, the second functional unit 1 has one first valve arrangement 13 per wheel brake 2. The first valve arrangements 13 are activatable for the brake pressure control at the corresponding wheel brake 2. Furthermore, the first valve arrangements 13 have in each case one first valve unit 14 connected in parallel with respect to the brake pressure generator 3 of the second functional unit 1. The first valve units are configured to, during the operation of the brake pressure generator 3 of the second functional unit 1, assume a blocking position at least counter to a conveying direction of the brake pressure generator 3, and to otherwise assume a passage position.

The second functional unit 1 has one second valve arrangement 15 per wheel brake 2. The second valve arrangements 15 are arranged in a fluid line between the at respective hydraulic fluid outlet 9, 11 of the brake pressure generator 3 of the second functional unit 1 and the wheel brake 2 assigned to the respective second valve arrangement 15.

The second valve arrangements 15 have in each case one fourth valve unit 16, which is configured to selectively assume a blocking position and/or passage position.

Two of the second valve arrangements 15 additionally have in each case one fifth valve unit 17, which is configured as a check valve which allows a flow of hydraulic fluid towards the respective wheel brake 2 and which has a blocking action in the opposite direction, wherein, here, the fourth valve unit 16 and fifth valve unit 17 are arranged in series. In each case one of these second valve arrangements 15 is assigned to one piston 7 of the multi-piston pump 6 or is situated in the brake circuit of the respective piston 7 of the multi-piston pump 6. In the present exemplary embodiment, in each case one of these two valve arrangements 15 is assigned to one rear-wheel brake RL, RR.

FIG. 2 schematically shows a hydraulic circuit diagram of a second variant of a second functional unit 18. The second functional unit 18 corresponds substantially to the second functional unit 1 as per FIG. 1 but, by contrast to this, has two second valve arrangements 15 which comprise a further fourth valve unit 16 instead of the additional fifth valve unit 17 configured as a check valve.

Otherwise, reference is additionally made to FIG. 1 and the associated description.

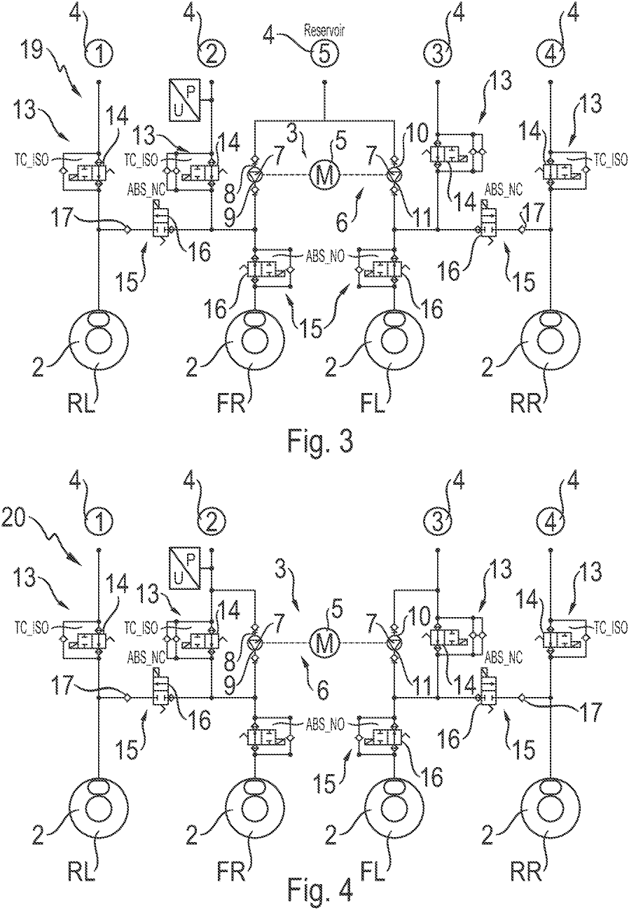

FIG. 3 schematically shows a hydraulic circuit diagram of a third variant of a second functional unit 19. The second functional unit 19 corresponds substantially to the second functional unit 1 as per FIG. 1.

In contrast to the first variant as per FIG. 1, the second functional unit 19 as per FIG. 3 has a fifth hydraulic fluid inlet 4, which is coupled or couplable to an unpressurized reservoir for hydraulic fluid. Furthermore, the two hydraulic fluid inlets 8, 10 of the brake pressure generator 3 of the second functional unit 19 are coupled or couplable via fluid lines exclusively to the fifth hydraulic fluid inlet 4 of the second functional unit 19. The fluid accumulators 12 can thus be omitted here.

Otherwise, reference is additionally made to FIGS. 1 and 2 and the associated description.

FIG. 4 schematically shows a hydraulic circuit diagram of a fourth variant of a second functional unit 20. The second functional unit 20 corresponds substantially to the second functional unit 1 as per FIG. 1.

In contrast to the first variant as per FIG. 1, no fluid accumulators 12 are provided. One hydraulic fluid inlet 8 of the brake pressure generator 3 of the second functional unit 20 is thus coupled or couplable via a fluid line to the second hydraulic fluid inlet 4 of the second functional unit 20. The other hydraulic fluid inlet 10 of the brake pressure generator 3 of the second functional unit 20 is coupled or couplable via a fluid line to the third hydraulic fluid inlet 4 of the second functional unit 20.

Otherwise, reference is additionally made to FIGS. 1 to 3 and the associated description.

FIG. 5 schematically shows a hydraulic circuit diagram of a fifth variant of a second functional unit 21. The second functional unit 21 corresponds substantially to the second functional unit 1 as per FIG. 1.

In contrast to the first variant as per FIG. 1, no fluid accumulators 12 are provided. Instead, the second functional unit 21 as per FIG. 5 has, similarly to the third variant as per FIG. 3, a fifth hydraulic fluid inlet 4, which is coupled or couplable to an unpressurized reservoir for hydraulic fluid. The two hydraulic fluid inlets 8, 10 of the brake pressure generator 3 of the second functional unit 21 are coupled or couplable via fluid lines to the fifth hydraulic fluid inlet 4 of the second functional unit 21.

Furthermore, the first valve arrangements 13 have in each case one valve unit 22 instead of the first valve units 14. The second valve units 22 are configured to couple the wheel brake 2 assigned to the respective first valve arrangement 13, for the purposes of increasing brake pressure, selectively to a hydraulic fluid inlet 4 of the second functional unit 21 and/or to the brake pressure generator 3 or to a hydraulic fluid outlet 9, 11 of the brake pressure generator of the second functional unit 21. As illustrated in FIG. 5, two first valve arrangements 13, or the second valve units 22 thereof, are assigned or coupled to the hydraulic fluid outlet 9 of the brake pressure generator 3 of the second functional unit 21. The other two first valve arrangements 13, or the second valve units 22 thereof, are assigned or coupled to the hydraulic fluid outlet 9 of the brake pressure generator 3 of the second functional unit 21.

The second functional unit 21 furthermore has one third valve arrangement 23 per wheel brake 2. The third valve units 23 may be configured to selectively dissipate brake pressure at the wheel brake 2 assigned to the respective third valve unit 23. For this purpose, the third valve units 23 have hydraulic fluid outlets 24 which are directed away from the wheel brakes 2 and which are coupled or couplable in each case to the fifth hydraulic fluid inlet 4 of the second functional unit 21 and thus to the unpressurized reservoir.

Otherwise, reference is additionally made in particular to FIGS. 1 to 4 and the associated description.

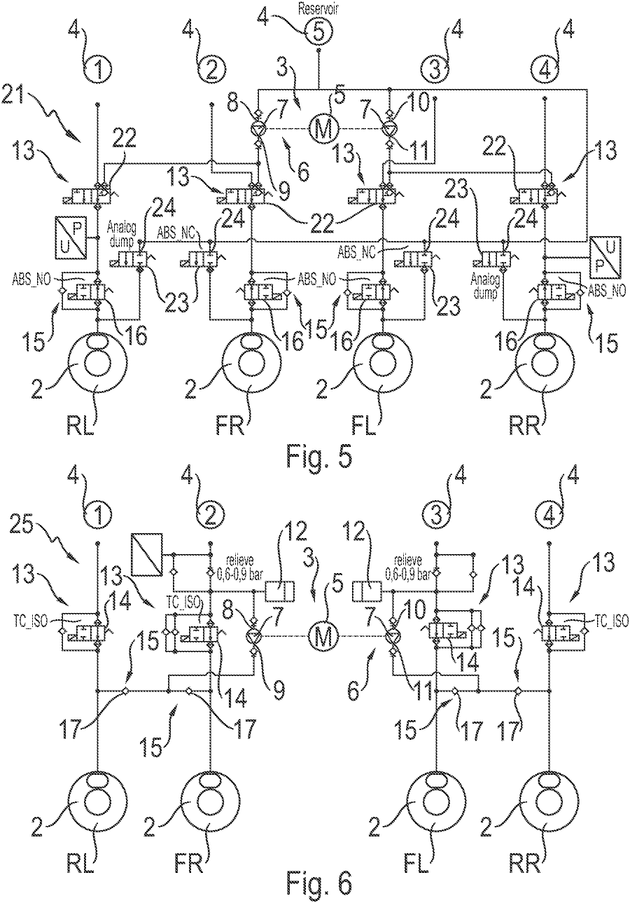

FIG. 6 schematically shows a hydraulic circuit diagram of a sixth variant of a second functional unit 25. The second functional unit 25 corresponds substantially to the second functional unit 1 as per FIG. 1.

In contrast to the first variant as per FIG. 1, all second valve arrangements 15 have in each case only one fifth valve unit 17, which is configured as a check valve. The check valves of the valve units 17 are configured such that a flow of hydraulic fluid, from the brake pressure generator 3 of the second functional unit 25, to the respective wheel brake 2 is allowed, and said check valves have a blocking action in the opposite direction.

Otherwise, reference is additionally made in particular to FIGS. 1 to 5 and the associated description.

The word “may” is used in particular to refer to optional features of the disclosure. Accordingly, there are also refinements and/or exemplary arrangements of the disclosure that additionally or alternatively have the respective feature or the respective features.

If necessary, isolated features may also be picked out from the combinations of features disclosed here and used, with the elimination of any structural and/or functional relationship that exists between the features, in combination with other features for the purposes of delimiting the claimed subject matter. The sequence and/or number of steps of the method may be varied.

1. A second functional unit for brake pressure control at each wheel brake of a multiplicity of wheel brakes in a redundant manner in relation to a first functional unit of a hydraulic motor vehicle brake system, comprising: at least one electrical brake pressure generator that is configured to generate a respective brake pressure, on a wheel-specific basis, at the multiplicity of wheel brakes.

2. The functional unit according to claim 1, the second functional unit has four inlets which are each coupled or couplable to an outlet, of the first functional unit, wherein the inlets of the second functional unit and/or the outlets of the first functional unit are assigned to in each case at least one wheel brake.

3. The functional unit according to claim 1, wherein the second functional unit comprises, for implementation of the brake pressure control, a first valve arrangement per wheel brake of the multiplicity of wheel brakes, wherein the first valve arrangement is activatable for the brake pressure control at the corresponding wheel brake.

4. The functional unit according to claim 3, wherein the first valve arrangements comprise in each case one first valve unit that is connected in parallel with respect to the at least one electrical brake pressure generator of the second functional unit.

5. The functional unit according to claim 4, wherein the first valve unit is configured to, during operation of the brake pressure generator of the second functional unit assume a blocking position at least counter to a conveying direction of the brake pressure generator, and/or to otherwise assume a passage position.

6. The unit according to claim 3, wherein the first valve arrangements comprise in each case one second valve unit which is configured to couple the wheel brake assigned to the respective first valve arrangement, for the purposes of increasing brake pressure, selectively to an inlet , ,of the second functional unit and/or to the brake pressure generator of the second functional unit.

7. The functional unit according to claim 1, wherein the second functional unit comprises a third valve unit per wheel brake of the multiplicity of wheel brakes, which third valve unit is configured to selectively dissipate brake pressure at the wheel brake assigned to the third valve unit.

8. The functional unit according to claim 1, wherein the brake pressure generator of the second functional unit has at least one inlet , which is coupled or couplable to an inlet of the second functional unit and/or to an outlet of the first functional unit.

9. The functional unit according to claim 1, wherein the second functional unit comprises at least one fluid accumulator provided at an inlet side of the brake pressure generator of the second functional unit.

10. The functional unit according to claim 9, wherein the at least one fluid accumulator is configured as a piston-type accumulator with a cylinder and with a piston received displaceably therein, wherein the piston has an accumulation position when the cylinder has been filled, and wherein the piston-type accumulator is arranged in a fluid path of at least one of the wheel brakes of the multiplicity of wheel brakes such that a hydraulic fluid flowing from the wheel brake in the direction of an inlet of the second functional unit and/or in the direction of the first functional unit can force the piston into its accumulation position.

11. The functional unit according to claim 1, wherein the brake pressure generator of the second functional unit has at least one inlet , which is coupled or couplable to a first unpressurized reservoir for hydraulic fluid of the first functional unit, and/or in that the second functional unit has a second unpressurized reservoir for hydraulic fluid, wherein the brake pressure generator of the second functional unit has at least one inlet , which is coupled or couplable to the second unpressurized reservoir for hydraulic fluid of the second functional unit.

12. The functional unit according to claim 11, wherein the second functional unit has a fifth inlet which is coupled or couplable to the first unpressurized reservoir for hydraulic fluid of the first functional unit, wherein the at least one inlet of the brake pressure generator of the second functional unit is coupled or couplable to the fifth inlet of the second functional unit.

13. The functional unit according to claim 11, wherein the outlets of the third valve units of the second functional unit which outlets are directed away from the wheel brakes, are coupled and/or couplable to the first unpressurized reservoir of the first functional unit and/or to the second unpressurized reservoir of the second functional unit.

14. The functional unit according to claim 1, wherein the at least one inlet of the brake pressure generator of the second functional unit is directed towards a corresponding inlet of the second functional unit and at least one outlet of the brake pressure generator of the second functional unit is directed towards at least one wheel brake of the multiplicity of wheel brakes.

15. The functional unit according to claim 1, wherein the second functional unit comprises a second valve arrangement per wheel brake of the multiplicity of wheel brakes, wherein the second valve arrangement is arranged in a fluid line between the at least one outlet of the brake pressure generator of the second functional unit and the wheel brake assigned to the respective second valve arrangement.

16. The functional unit according to claim 15, wherein the second valve arrangements comprise in each case at least one fourth valve unit that is configured to selectively assume a blocking position and/or passage position.

17. The functional unit according to claim 15 wherein at least one, of the second valve arrangements has two fourth valve units, which are arranged in series.

18. The functional unit according to claim 17, wherein the second valve arrangements comprise in each case at least one fifth valve unit, which is configured as a check valve which allows a flow of hydraulic fluid to the respective wheel brake and which has a blocking action in the opposite direction.

19. The functional unit according to claim 15 wherein at least one, of the second valve arrangements comprise(s) a fourth valve unit which is configured to selectively assume a blocking position and/or passage position, and a fifth valve unit which is configured as a check valve which allows a flow of hydraulic fluid to the respective wheel brake and which has a blocking action in the opposite direction, wherein the fourth and fifth valve units are arranged in series.

20. The functional unit according to claim 1, wherein the multiplicity of wheel brakes comprises all wheel brakes of the motor vehicle brake system or of the motor vehicle, and/or the second functional unit is configured such that the brake pressure generator of the second functional unit can implement an in particular wheel-specific brake pressure buildup at all wheel brakes of the motor vehicle.

21. The functional unit according to claim 1, wherein the brake pressure generator of the second functional unit comprises twofluid-conveying devices which are actuatable by an electric motor.

22. The functional unit according to claim 21, wherein the motor vehicle brake system comprises two front-wheel brakes and two rear-wheel brakes wherein in each case one front-wheel brake and one rear-wheel brake are jointly assigned and/or connected to one fluid-conveying device and/or wherein the two front-wheel brakes are jointly assigned and/or connected to one fluid-conveying device and the two rear-wheel brakes are jointly assigned and/or connected to the other fluid-conveying device.

23. The functional unit according to claim 1, wherein the brake pressure generator of the second functional unit comprises a double-acting cylinder-piston arrangement that is actuatable by an electric motor.

24. The functional unit according to claim 1, wherein the brake pressure generator of the second functional unit comprises a multi-piston pump, which is actuatable by an electric motor wherein in each case at least two of the wheel brakes are jointly assigned and/or connected to one piston of the multi-piston pump.

25. The functional unit according to claim 24, wherein the multi-piston pump comprises two pistons, and the motor vehicle brake system comprises two front-wheel brakes and two rear-wheel brakes , wherein in each case one front-wheel brake and one rear-wheel brake are jointly assigned and/or connected to one piston, and/or wherein the two front-wheel brakes are jointly assigned and/or connected to one piston and the two rear-wheel brakes are jointly assigned and/or connected to the other piston.

26. The functional unit according to claim 1, wherein the wheel brakes, or the front-wheel brakes and rear-wheel brakes are connected to the second functional unit.

27. A hydraulic motor vehicle brake system with redundant brake pressure control, comprising:
- a first functional unit, with a first electrical brake pressure generator that is configured to generate a respective brake pressure at a multiplicity of wheel brakes; and
- a second functional unit which is configured according to claim 1, wherein the second functional unit is configured to implement a brake pressure at each wheel brake of the multiplicity of wheel brakes , on a wheel-specific basis, in a redundant manner in relation to the first functional unit.

28. A method for operating a hydraulic motor vehicle brake system according to claim 27, wherein the method comprises the steps:
- detecting a requirement for brake pressure control in the absence of functionality of the first functional unit; and
- in response to the detection, performing brake pressure control at at least one wheel brake of the multiplicity of wheel brakes by the second functional unit .

29. (canceled)
